(19) United States
(12) Patent Application Publication
(10) Pub. No.: US 2015/0132500 A1
(43) Pub. Date: May 14, 2015

(54) COMPACT REEL COATING/WASHING SYSTEM

(71) Applicant: Harland Medical Systems, Inc., Eden Prairie, MN (US)

(72) Inventors: Kevin A. Fleishhacker, Maple Grove, MN (US); David L. Klenk, Eden Prairie, MN (US)

(21) Appl. No.: 14/503,183

(22) Filed: Sep. 30, 2014

Related U.S. Application Data
(60) Provisional application No. 61/884,544, filed on Sep. 30, 2013.

(51) Int. Cl. B05C 3/12; B05D 1/18; B05C 11/10

(52) U.S. Cl. CPC B05C 3/12; B05C 11/10; B05D 1/18
USPC 427/434.5; 118/421

(57) ABSTRACT

A coating or washing apparatus and method that utilizes a reel to receive tubings, the tubings receive elongate flimsy members at tubing inlets and provide circulating fluid for coating the flimsy members. An elevator raises and lowers tubing inlets while maintaining fluid circulation; the raising corresponds with an unwinding of the tubings from the reel and lowering the tubing inlets corresponds with winding the tubings on the reel.

### CROSS-REFERENCE TO RELATED APPLICATION

This application claims the benefit under 35 U.S.C. §119(e) to U.S. Provisional Patent Application No. 61/884,544, filed Sep. 30, 2013, which is hereby incorporated by reference herein in its entirety.

### FIELD OF THE INVENTION

This application relates to apparatus and methods for coating elongate flimsy members.

### BACKGROUND OF THE INVENTION

Elongate flimsy members used in medical procedures, such as guide wires, may be up to 300 cm long and 0.013 inches or less thick. These are problematic in handling particularly when then need to be coated with coatings such as biological coatings. U.S. Pat. No. 8,133,545 discloses a method for inserting such elongate flimsy members into tubings sections where the coating fluid circulates and where the members may then be coated and removed. For handling long members the vertical and/or horizontal space requirements of the equipment to support the long lengths of tubings can be excessively tall and/or deep. Reduction in the space requirements for treatment of such long flimsy members would be advantageous.

### SUMMARY OF THE INVENTION

An apparatus for coating elongate flimsy members comprises a plurality of tubings extending from a tank region and providing fluid circulation into each of the tubings. The tubings extend downwardly from the tank region to a reel. Each tubing at the an inlet end where the circulating fluid may enter and an opposite end where the fluid leaves the treatment tubing to a pump where the fluid may be recirculated. The reel is operative to wind the tubings around the reel, whilst allowing the circulating fluid to continue to circulate. In a wound position on the reel, the long flimsy members may be conveniently inserted into the tubings inlets while the fluid is flowing. In an embodiment, several, for example four, such long flimsy members may be inserted into a single tubings inlet. After loading the members, the tank region may be raised by a lift mechanism and unwinding the tubings wound on the reel such that the tubings containing the long flimsy members extends vertically or substantially vertically.

A feature and advantage of embodiments of the invention is that a dramatically reduced floor footprint over conventional methods of tubing management is provided.

A feature and advantage of embodiments of the invention is that a compact design that reduces manufacturing cost of the equipment, 1 frame vs. 2 attached frames, is provided.

A feature and advantage of embodiments of the invention is that an easy, faster and more complete drain method for draining of tubings is provided by raising the dip block and allowing the designer to pick the drain angle of the tubings through the reel section.

A feature and advantage of embodiments of the invention is providing a convenient operator load height while still providing the means to raise the device being dip coated or washed to hang straight during the dipping cycle.

A feature and advantage of embodiments of the invention is that the complexity of the pumping system is reduced by allowing the pump assembly to be stationary

A feature and advantage of embodiments of the invention is that continuous recirculation at any position and while moving from load height to fully raised height is provided. Moreover, a tubing opening where the long flimsy member extends, can remain open as the reel is raised and lowered.

A feature and advantage of embodiments of the invention is facilitating automated solution/solvent filling, mixture control, and characterization due to the continuous recirculation ability.

### DESCRIPTION OF THE FIGURES

FIG. 1 illustrates a perspective view of a coating apparatus for elongate flimsy members in a loading position;

FIG. 2 illustrates the coating apparatus of FIG. 1 with the apparatus in a coating position;

FIG. 3 is an end elevational view of the coating apparatus of FIGS. 1 and 2.

FIG. 4 is a front elevational view of the coating apparatus of FIGS. 1-3.

FIG. 5 is fluid flow and component schematic.

FIG. 6 is a elevational view of an embodiment of the coating apparatus with the flimsy members suspended above the openings and the coating tubings wound on a reel.

FIG. 7 is an elevational view of the embodiment of FIG. 6 with the elevator raised and the flimsy members in the coating tubings and the tubings unwound from the reel.

### DETAILED DESCRIPTION

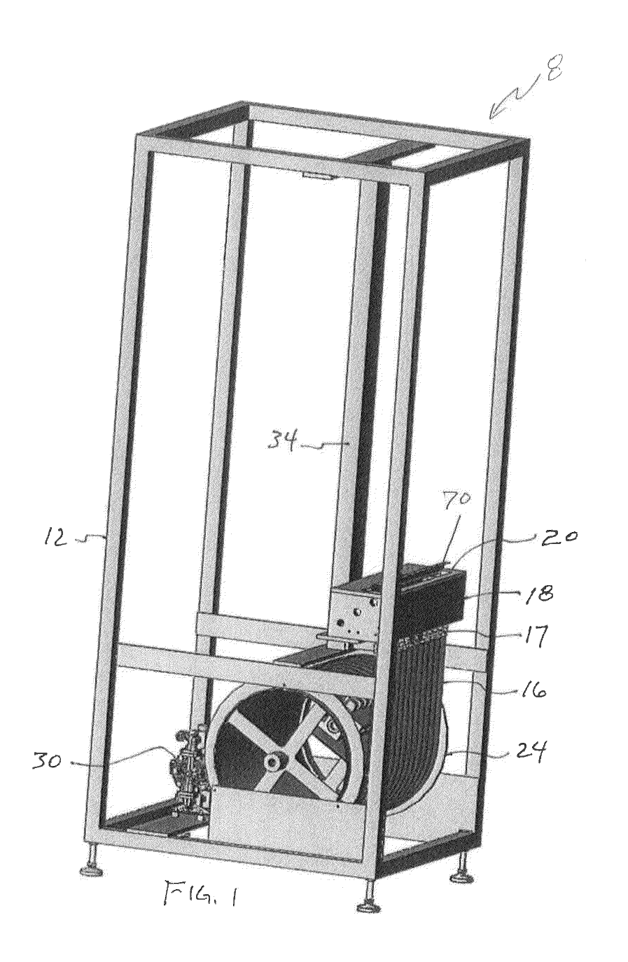

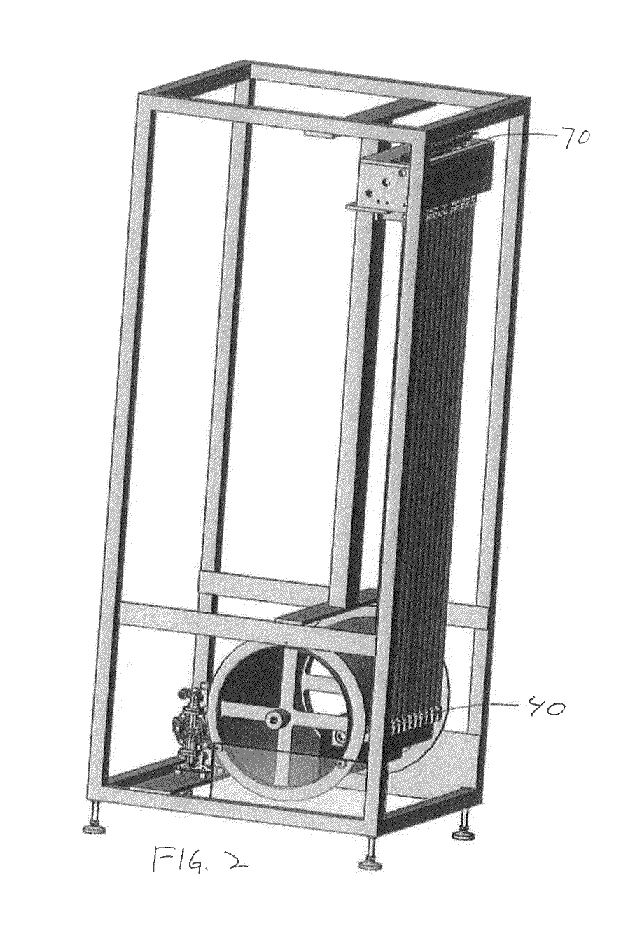

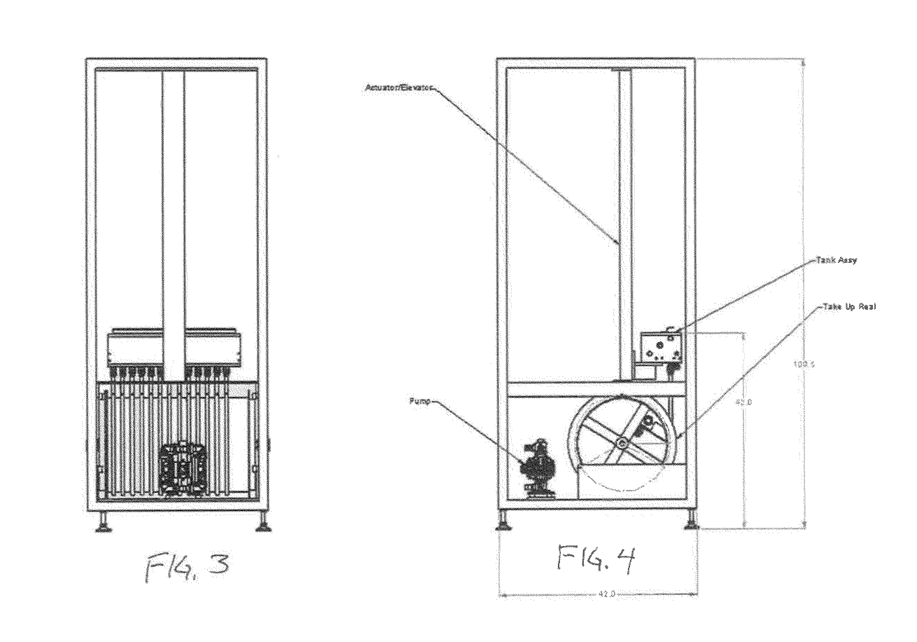

An apparatus 8 for coating long flimsy members 10 with fluid coatings is shown in FIGS. 1-4 and comprises a structural support 12, a plurality of coating tubings 16, with tubings inlets 17, a tubings inlet support 18 including a tank 20, a reel 24 to wind the tubings thereon, a pump 30 for circulating fluid through the tubings, and an elevator 34 for raising the tubings inlet support and tank. The tubings inlet support and tank moves vertically by way of the elevator 34. The tank at the tubings inlet support may be supplied the fluid by way of the pump 30. The tubings have outlets 40 that may be connected to the pump. A fluid reservoir 41 may be inserted in the system, for example at the pump outlet.

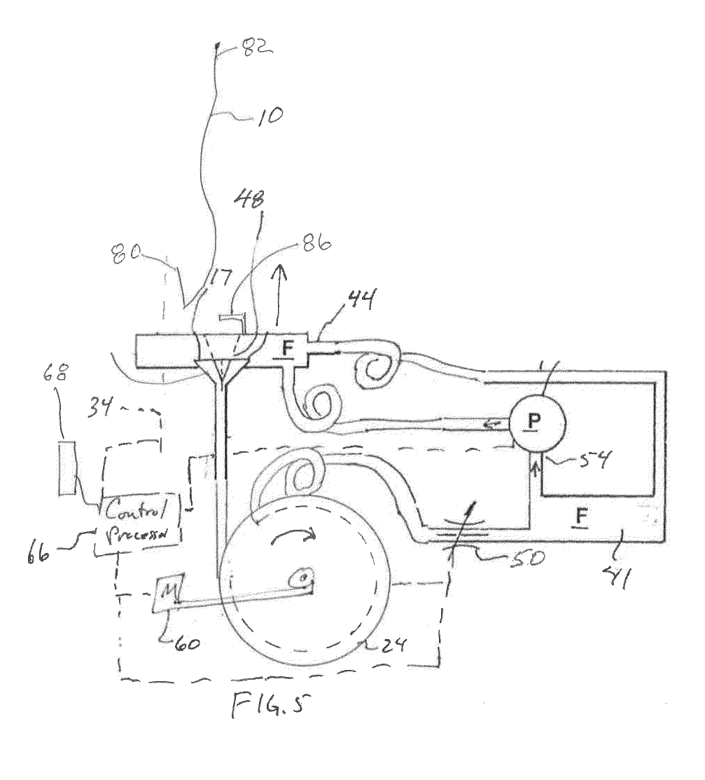

A schematic view of the plumbing flow is illustrated in FIG. 5. Although a single tubing is illustrated, the plurality of tubings as illustrated in FIGS. 1-4 is contemplated. The pump may provide fluid to the tubings inlets 17 such that the fluid flows the length of the tubings and out the tubing outlets 40. The tubing outlets 40 may be regulated by a valve 50 to control the fluid flow through the tubings, with the tubings outlet and an overflow outlet 44 on the movable tank connected to the pump inlet 54. The inlets may be configured to provide a vortex 48 of the circulating fluid at the tubing inlets 17. A coating system is illustrated in U.S. Pat. No. 8,133,545, incorporated herein by reference, has components with some of the same functionality.

The reel 24 may be controlled by a motor 60 that is synchronized with the elevator. Alternatively, the reel may be biased by a spring to simply keep the tubing taught such that the raising or lowering of the elevator winds or unwinds the tubing on the reel. A control processor 66 can coordinate the operation of the components according to user inputs. Parameters such as timing, fluid temperature, circulation speed may be input at a user interface 68.

The lowering of the elevator and the corresponding winding of the tubings on the reel allows the long flimsy members 10 to be inserted into the tubing openings, distal end 80 first. In some the members may be inserted manually individually instances with the tubing wound up on the reel. Then proximal end 82 may be secured at the opening by a clamping member or other fixation means and the elevator raised. In an embodiment, the elevator may be raised after insertion of the elongate flimsy members and fluid circulated or continued to be circulated after the elevator is raised.

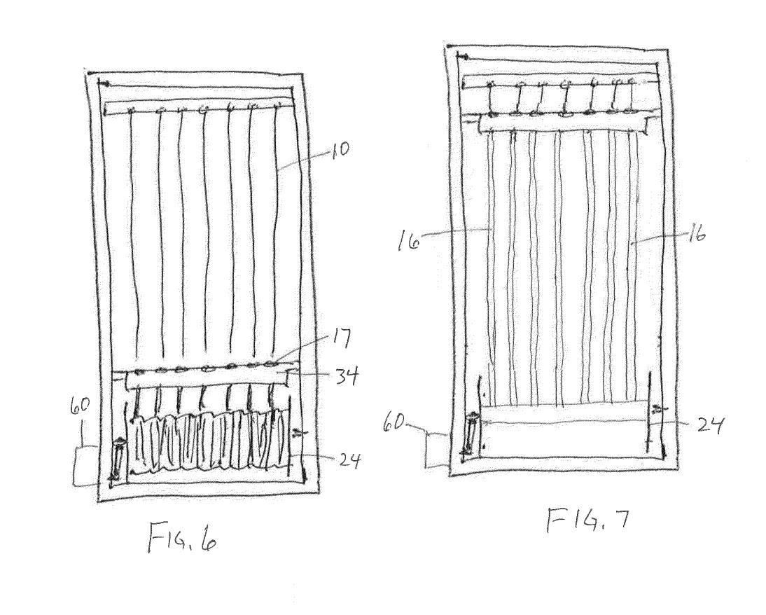

Referring to FIGS. 6 and 7, in another embodiment, the elongate flimsy members 10 are fixed above the elevator with the elevator in a lowered position, the tubings wound on the reel. With the elongate members fixed in position and the distal ends of the elongate members guided into access openings of the tubings, the elevator is raised, simultaneously unreeling the tubing and inserting the elongate flimsy members into the tubing. In embodiments, the apparatus such as illustrated in U.S. Pat. No. 7,597,937, owned by the owner of the instant invention and incorporated herein by reference, may be utilized in conjunction with the apparatus for alignment and insertion of multiple elongate flimsy members into the tubings.

1. A method of coating elongate flimsy members comprising:
winding a tubing on a reel with an upwardly facing access to the tubing at a first end of the tubing;
insertion of an elongate flimsy member into the upwardly facing access opening and into the tubing;
raising the first end of the tubing thereby unwinding the tubing on the reel whereby the elongate flimsy member is extending substantially vertically in the tubing;
circulating fluid in the tubing with the tubing.

2. The method of claim 1 wherein the insertion of the elongate flimsy member comprises a portion of a length of the elongate flimsy member and the raising of the first end continues the insertion of the elongate flimsy member into the tubing.

3. The method of claim 1 wherein the insertion of the elongate flimsy member into the tubing occurs during the raising of the first end.

4. A method of coating elongate flimsy member comprising:
winding plurality of coating tubings on a reel;
insertion of elongate flimsy members to be coated into the tubings as the coating tubings are unwound from the reel.

5. The method of claim 4 further comprising unwinding the reel while raising an elevator supporting the tubings.

6. The method of claim 5 further comprising circulating a biological coating fluid through the plurality of coating tubings when the coating tubings are unwound from the reel for coating the elongate flimsy members.

7. An apparatus for coating a plurality of elongate flimsy members comprising:
a support structure holding a reel,
a plurality of coating tubings wound on the the reel;
the coating tubings each having an access end for the elongate flimsy members and said access ends are supported in an elevator vertically movable within the support structure;
the coating tubings each connected to a fluid circulation system for a coating fluid;

8. The apparatus of claim 7 further comprising an elongate flimsy member hanging support positioned above the elevator for attachment of the plurality of elongate flimsy members.

9. The apparatus of claim 7 wherein the elevator has upwardly facing entry openings for the elongate flimsy members

10. The apparatus of claim 7 further comprising a control processor for controlling operation of the elevator and the fluid circulation system.
